(19) United States
(12) Patent Application Publication
(10) Pub. No.: US 2003/0108066 A1
(43) Pub. Date: Jun. 12, 2003

(54) Packet ordering

(76) Inventor: Daniel Trippe, Sudbury, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/162,809

(22) Filed: Jun. 5, 2002

Related U.S. Application Data
(60) Provisional application No. 60/340,882, filed on Dec. 12, 2001.

(51) Int. Cl. H04L 12/28

(52) U.S. Cl. 370/474; 370/394

(57) ABSTRACT

A method and system for use in ordering packets received over a network, that include storing in a content-addressable memory information corresponding to at least two received packets, where the information includes sequence identifiers of the packets. The method and system also include retrieving at least a portion of the information from the content-addressable memory using the sequence identifiers of the at least two received packets.

### REFERENCE TO RELATED APPLICATION

This application claims priority to U.S. Provisional Application Serial No. 60/340,882, filed on Dec. 12, 2001, entitled “ORDERING PACKETS USING A CONTENT ADDRESSABLE MEMORY,” the contents of which are herein incorporated by reference in their entirety.

### BACKGROUND

Networks enable computers to exchange electronic information such as e-mail, internet web-pages, chat messages, audio, and video. Information sent between computers can be divided into a collection of smaller pieces known as packets. Packets may be independently sent on their way to their network destination. A computer receiving the packet can reassemble them into the original information. As an example, a protocol known as TCP/IP (Transmission Control Protocol/Internet Protocol) divides an original message into a collection of TCP/IP packets that each carry some small portion of the original message across a network. A computer receiving the packets can reconstitute the original message by reassembling the packets in the correct order.

Sometimes packets arrive at the computer out of order. For example, due to different paths taken across a network, a packet storing the start of the message may arrive after a packet storing the end of the message. To permit proper reordering by the receiving computer, packets often include sequencing information such as a number identifying the place of the packet within a collection of packets.

### SUMMARY

The disclosure describes a method for use in ordering packets received over a network. The method includes storing in a content-addressable memory information corresponding to different received packets that includes sequence identifiers of the packets. The method also includes retrieving at least a portion of the information from the content-addressable memory using the sequence identifiers of the different packets.

Embodiments may include one or more of the following features. The packet may be an ATM (Asynchronous Transfer Mode) cell packet, frame fragment packet, or other packet. The method may further include storing the received packets in a memory and storing a reference to the location of the packet in the content-addressable memory. The method may further include ordering the packets in accordance with their sequence identifiers. The packets may be received in an order different than an order corresponding to their sequence identifiers. The information stored in the content-addressable memory a packet may include one or more semaphores. The retrieving may include generating a series of retrievals corresponding to a sequential indexing from a first sequence identifier. The method may further include determining when to order the packets (e.g., when the last packet in a set of packets is received).

The disclosure also describes a system for use in ordering packets received over a network. The system includes a content-addressable memory and instructions for causing a processor to store in a content-addressable memory information corresponding to different received packets. The information for a packet includes a sequence identifier of the packet. The instructions also cause the processor to retrieve at least a portion of the information from the content-addressable memory using the sequence identifiers of the different packets.

In an embodiment, the system includes means for storing in a content-addressable memory information corresponding to different received packets where the information for a packet includes a sequence identifier of the packet. The system also includes means for retrieving at least a portion of the information from the content-addressable memory using the sequence identifiers of the different packets.

The disclosure also describes a computer program product, disposed on a computer readable medium, for use in ordering packets received over a network. The program includes instructions for causing a processor to store in a content-addressable memory information corresponding to different received packets, the information for a packet including a sequence identifier of the packet. The program also includes instructions for causing the processor to retrieve at least a portion of the information from the content-addressable memory using the sequence identifiers of the different packets.

### BRIEF DESCRIPTION OF THE DRAWINGS

FIGS. 1 to 6 are diagrams illustrating operation of a system that uses a content-addressable memory to order packets.

FIGS. 7-8 are flowcharts of a process for ordering packets using a content-addressable memory.

### DETAILED DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

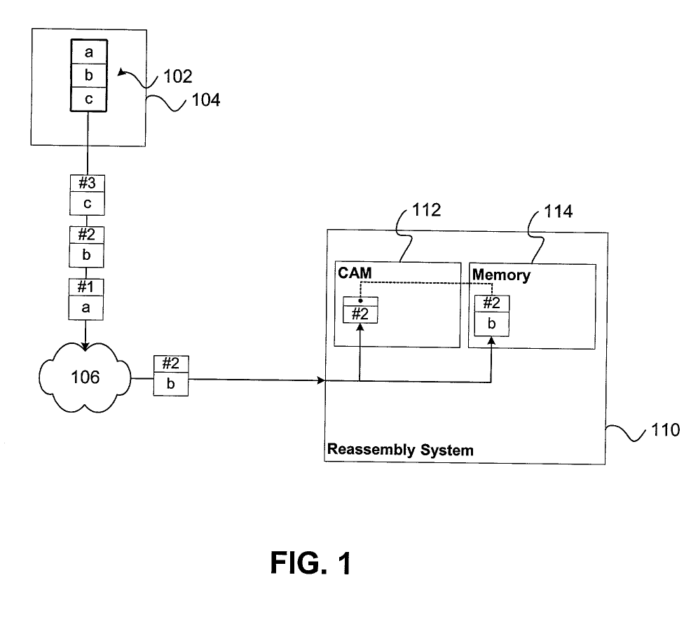

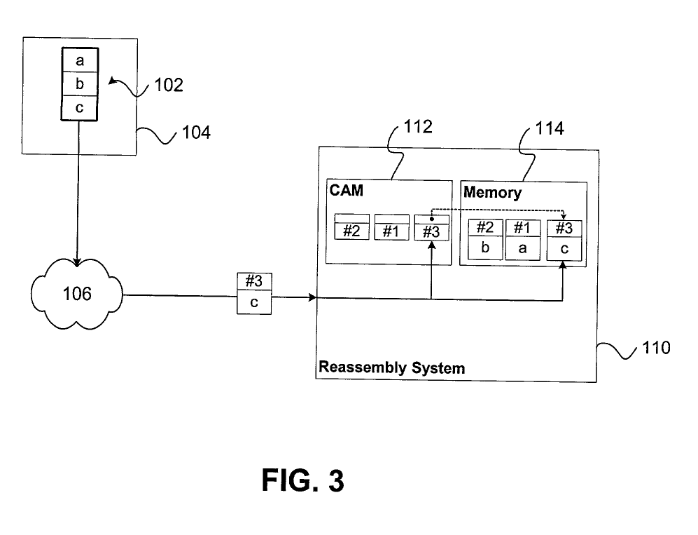

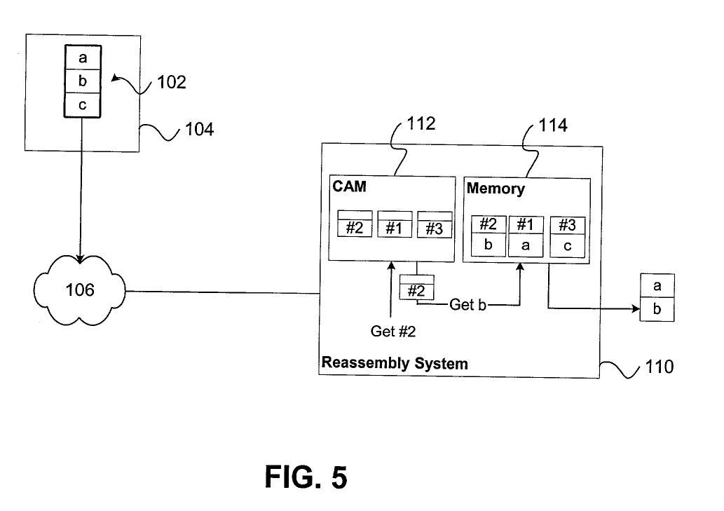

FIGS. 1 to 6 illustrate operation of a system 110 that reorders a received collection of packets 102 into their original sequence. As shown, the system 110 includes a storage device known as a “content-addressable memory” (CAM). The content-addressable memory 112 enables the system 110 to order the packets into their proper sequence though the packets may have arrived out of order.

Content-addressable memory 112 devices differ from conventional memory chips in the way data is retrieved. Conventional memory retrieves data based on a specified memory address. For example, if a conventional memory stored information about a packet at address “0258”, the packet could be retrieved by requesting the contents of address “0258”. The address, “0258”, used to store the packet information may bear little, if any, relation to the packet's order within a sequence of packets.

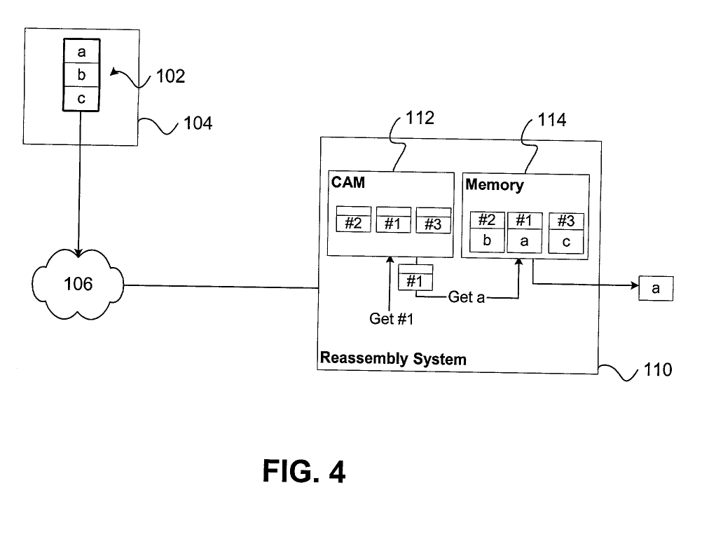

Unlike conventional memory, however, content-addressable memory 112 searches for data that matches specified content. For example, if a content-addressable memory 112 stored information including the sequence number of a packet, the information could be retrieved by requesting contents matching a particular sequence number instead of a particular memory address. As illustrated in FIGS. 4-6, by generating a series of CAM requests for a series of sequence numbers, the system 110 can sort the packets into their correct sequence.

In greater detail, FIG. 1 shows an original set of data 102. For example, the data 102 may be a data link layer frame. As shown, the data 102 is divided into a set of packets #1, #2, #3 for transmission over a network 106. In this example, packet #1 carries the beginning portion of the data 102 (“a”), while packet #3 carries the end portion (“c”). As shown in FIGS. 1-3, the packets #1, #2, #3 include information (e.g., a sequence number) identifying their order within the original data 102. The packets #1, #2, #3 may also include other information such as semaphore flags identifying the first and last packets in the set of original data 102.

As illustrated in FIGS. 1-3, the system 110 stores the packets in memory 114 (e.g., RAM) as the packets arrive. The system 110 also stores a context for received packets in the content-addressable memory 112. The context can include the sequence number of the packet, semaphore flags, and/or other information. The context can also include a reference (e.g., a pointer) to the location of the packet in memory 114. The use of contexts conserves content-addressable memory 112 storage space.

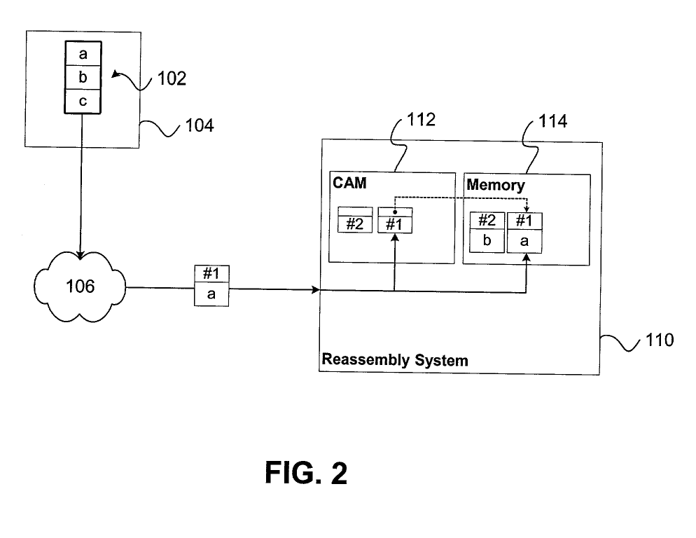

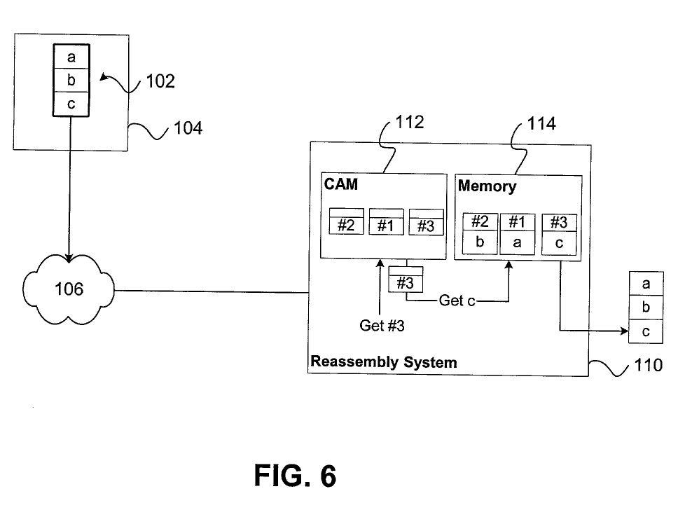

As shown in FIGS. 1-3, the packets #1, #2, #3 may not arrive in order. For example, as illustrated, the system 110 may receive packet #2 (FIG. 1) before packet #1 (FIG. 2). As shown in FIGS. 4-6, to re-order the packets into their original order, the system 110 can issue a series of requests to the content-addressable memory 112. For example, the system 110 can issue a series of requests that begin with the sequence number of the first packet #1 in the data 102 (FIG. 4) and ends at the sequence number of the last packet #3 (FIG. 6). In response to a request, the content-addressable memory 112 retrieves the context corresponding to the sequence number. This, in turn, permits the system 110 to locate the corresponding packet from memory 114 using the context pointer. As the packets are located, the system 110 can organize them to reconstitute the original set of data 102.

For conceptual clarity, FIGS. 4-6 show the system 110 outputting the packets in their correct order. However, the system 110 may instead reassemble the packets into their original form 102 within memory 114. For example, the system 110 may chain the packets together into a linked list ordered in the correct sequence.

The approach illustrated in FIGS. 1 to 6 can be implemented in a wide variety of ways. For example, aspects of the system 110 may be implemented in hardware, firmware, software or a combination thereof. Additionally, the approach may be applied to a wide variety of packets at different levels in a network protocol stack such as TCP/IP or UDP (User Datagram Protocol) packets, frame fragment packets, ATM cells, and so forth.

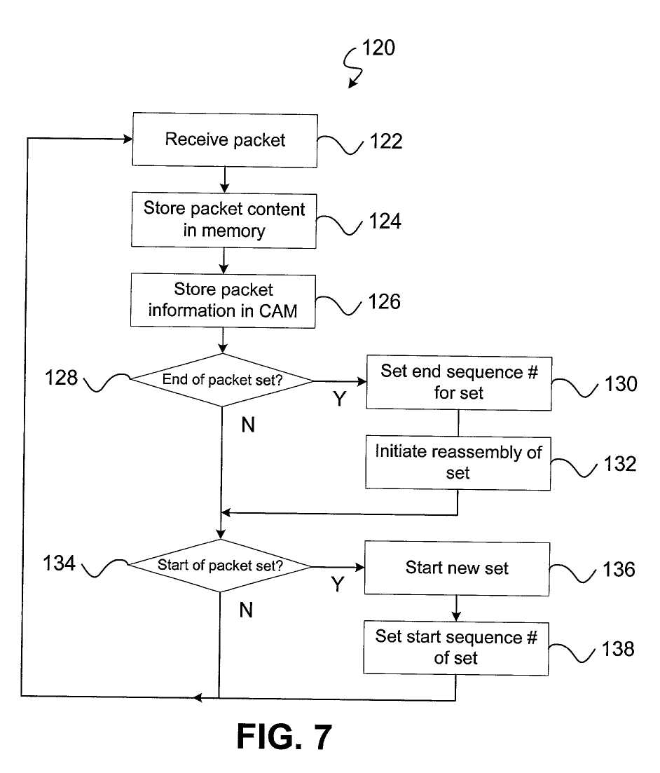

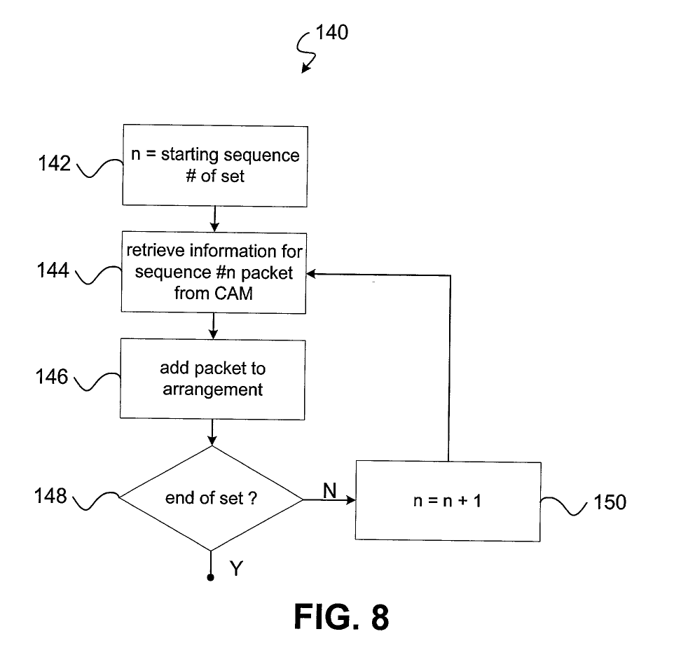

FIGS. 7 and 8 illustrate operation of a sample process 120 that reassembles different sets of packets. As shown in FIG. 7, after receiving 122 a packet, the process 120 stores 124 the packet in memory. The process 120 also stores 126 a corresponding context for the packet in content-addressable memory.

The process 120 determines whether received packet constitutes the first 134 or last 128 packet in a set. For example, the process 120 may examine beginning (e.g., B=1) or ending (e.g., E=1) semaphore flags of the packet to determine whether it begins or ends a set of packets.

If a given packet begins a new set (e.g., B=1), the process 120 can allocate a new “packet-set context” that includes fields for storing the starting and ending sequence numbers and, thereafter, set 138 the starting sequence number of the new context.

If the process 120 detects a packet ending a set (e.g., E=1), the process 120 can initiate reassembly of the set. FIG. 8 illustrates an example of a reassembly process 140. As shown, the process 140 accesses data (e.g., the packet-set context) identifying the starting sequence number 142 and queries 144 the content-addressable memory for the context associated with that sequence number. The process 140 adds 146 the corresponding packet to the ordered arrangement, for example, by linking the packet into a linked list. This process 140 can continue with incrementally greater 150 sequence numbers, until the process 140 finds a context having a semaphore flag identifying the packet as the end of the set.

When the process 140 completely sequences the set of packets, the process 140 can output the set. Alternatively, the process 140 can incrementally output packets as they are retrieved. After a set of packets has been processed, the process 140 can free the contexts and packets from the content-addressable memory and conventional memory, respectively.

Potentially, the search for a particular sequence number from the content-addressable memory may fail. For example, the system 110 may not yet have received a particular packet. In such an event, the system 110 may mark the set as errored and then free memory used to store the packets and associated contexts. Alternatively, the system can wait some duration for receipt of the missing packet before concluding reception of the complete set has failed.

The approach described above may be applied to a wide variety of communication mechanisms that subdivide data. For example, the approach may be used to reassemble packets transmitted in accordance with a Multilink PPP (Point-to-Point Protocol) scheme.

In greater detail, Multilink PPP employs fragmentation of packets into smaller fragment packets. These fragment packets are sent simultaneously over multiple links (“a bundle”) to the same remote address. A fragment packet includes a sequence number and semaphore flags that identify the start or end of a collection of fragment packets constituting a greater packet (i.e., B=1 for beginning; E=1 for end).

A reassembly system can store received fragment packets in memory. In additional to storing the fragment packet, the system can store a context of the fragment packet in content-addressable memory. The context can include a sequence number, semaphore flags, and a pointer to the location of the fragment packet in memory. Since a receiver may terminate multiple bundles, the context may also include a bundle number identifying the bundle carrying the fragment packet.

If a fragment packet includes a semaphore flag of B=1, the system allocates a “packet-set context” for storing the starting and ending sequence numbers of the packet. The new packet context is assigned a packet-set context number and the starting sequence number is set to the sequence number of the received fragment.

If a fragment includes a semaphore flag of E=1, the packet number is written to a queue for assembly. A fragment may include semaphore flags of B=1 and E=1. In this case, both a new packet-set context is created and the corresponding packet-set context number is immediately written to the queue for assembly.

This procedure produces a set of entries in the content-addressable memory which can be retrieved by querying the content-addressable memory for data associated with a particular bundle number/sequence number pairing. In response to such a request, the content-addressable memory returns the corresponding semaphore flags and pointer to the specified fragment packet in memory.

To reassemble the fragments using the content-addressable memory, a reassembly process continually “pops” packet numbers from the queue and accesses the corresponding packet-set context. The system then begins searching the content-addressable memory starting with the first sequence number identified by the packet context. As a check, the system can verify that the semaphore flags of the first packet fragment include a semaphore of B=1. Thereafter, the system can query the content-addressable memory for incrementally greater sequence numbers until a packet context is retrieved having a semaphore of E=1.

The implementation can dynamically chain the packets into a correctly ordered linked list. For example, the implementation can store packets with a data structure that stores not only a packet, but a pointer to the next packet. The implementation can add a packet to the list by setting the pointer of a previously added packet to the location of the packet being added.

After the system adds the final fragment to the arrangement, the packet fragments can be output in their correct order. For example, a process may navigate through the fragments in the order defined by the linked list. Thereafter, the contexts and data structures stored in the content-addressable memory and the memory can be freed.

As an additional example, the approach described herein can also be used to reassemble Multilink Frame Relay fragment packets. Multilink Frame Relay offers Virtual Connections between network devices. A bundle of physical or logical links can support many different Virtual Connections.

Since Multilink Frame Relay fragment packets use the same semaphore convention as Multilink PPP and include sequence numbers, the application of the techniques described herein are very similar between the two technologies. However, since bundles can support many Virtual Connections, a multilink frame relay implementation identifies not only the bundle carrying the fragment, but also the virtual connection. Thus, a content-addressable memory for a multilink frame relay implementation can store the bundle number, virtual connection number, sequence number, semaphore flags, and pointer to the stored frame fragment packet. The content-addressable memory is queried by specifying a particular bundle number/virtual connection number/sequence number triad. Otherwise, the process for reordering the packets proceeds similar to the descriptions provided above.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

The processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, or another device capable of being integrated with a processor(s) that can operate as provided herein. Accordingly, the devices provided herein are not exhaustive and are provided for illustration and not limitation.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method for use in ordering at least two packets received over a network, the method comprising:
storing in a content-addressable memory information corresponding to the at least two received packets, where the information includes a sequence identifier, and
retrieving at least a portion of the information from the content-addressable memory using the sequence identifiers for the at least two received packets.

2. The method of claim 1, wherein the at least two received packets comprise at least one ATM (Asynchronous Transfer Mode) cell.

3. The method of claim 1, wherein the at least two received packets comprise at least one frame fragment.

4. The method of claim 1, further comprising:
storing the at least two received packets in memory, and
wherein the information corresponding to the at least two received packets comprises a reference to the location of the at least two received packets in the memory.

5. The method of claim 1, further comprising ordering the at least two received packets in accordance with their sequence identifiers.

6. The method of claim 5, wherein the at least two received packets are received in an order different than an order corresponding to their sequence identifiers.

7. The method of claim 1, wherein the information of a corresponding packet comprises one or more semaphores.

8. The method of claim 1, wherein retrieving comprises generating a series of retrievals corresponding to a sequential indexing from a first sequence identifier.

9. The method of claim 1, further comprising determining when to order the at least two received packets.

10. The method of claim 9, wherein determining when to order the at least two received packets comprises determining when the last packet is received.

11. The method of claim 1, further comprising determining if a packet is missing.

12. A system for use in ordering at least two packets received over a network, the system comprising:
a content-addressable memory, and
instructions for causing a processor to:
store in a content-addressable memory information corresponding to the at least two received packets, the information including a sequence identifier, and,
retrieve at least a portion of the information from the content-addressable memory using the sequence identifiers of the at least two received packets.

13. The system of claim 12, wherein the at least two received packets comprise at least one ATM (Asynchronous Transfer Mode) cell.

14. The system of claim 12, wherein the at least two received packets comprise at least one frame fragment.

15. The system of claim 12, further comprising:
instructions for causing the processor to store the at least two received packets in a memory, and
wherein the information comprises a reference to the location of the at least two received packets in the memory.

16. The system of claim 12, further comprising instructions for causing the processor to order the at least two received packets in accordance with their sequence identifiers.

17. The system of claim 16, wherein the at least two received packets are received in an order different than an order corresponding to the sequence identifiers.

18. The system of claim 12, wherein the information of a corresponding of the at least two received packets comprises one or more semaphores.

19. The system of claim 12, wherein instructions for causing the processor to retrieve comprise instructions for causing the processor to generate a series of retrievals corresponding to a sequential indexing from a first sequence identifier.

20. The system of claim 12, further comprising instructions for causing the processor to determine when to order the at least two received packets.

21. The system of claim 12, further comprising instructions for causing the processor to determine if a packet is missing.

22. A system for use in ordering at least two packets received over a network, the system comprising:
means for storing in a content-addressable memory information corresponding to the at least two received packets, the information including a sequence identifier, and
means for retrieving at least a portion of the information from the content-addressable memory using the sequence identifiers of at least two received packets.

23. A computer program product, disposed on a computer readable medium, for use in ordering at least two packets received over a network, the program including instructions for causing a processor to:
store in a content-addressable memory information corresponding to at least two received packets, the information including a sequence identifier, and
retrieve at least a portion of the information from the content-addressable memory using the sequence identifiers of the at least two received packets.
